(19) United States
(12) Patent Application Publication
(10) Pub. No.: US 2011/0208616 A1
(43) Pub. Date: Aug. 25, 2011

(54) CONTENT SYSTEM

(76) Inventors: Christopher Simon Gorman, Bridge of Weir (GB); Nicholas R.C.G. Lycett, London (GB)

(21) Appl. No.: 12/997,848

(22) PCT Filed: Jun. 12, 2009
(86) PCT No.: PCT/GB2009/001506

§ 371 Date: Mar. 7, 2011

Related U.S. Application Data
(60) Provisional application No. 61/061,547, filed on Jun. 13, 2008.
(60) Provisional application No. 61/153,589, filed on Feb. 18, 2009.

(51) Int. Cl. G06Q 30/00; G06F 15/16; H04L 9/32

(52) U.S. Cl. 705/27.1; 709/219; 713/176

(57) ABSTRACT

Systems, methods, and an article of manufacture for managing media content are shown and described. A method can include storing a plurality of collection maps on a server in communication with a network, each collection map each indicating how music content items making up a music content item collection associated with a user account are held across a plurality of music devices associated with the user account. The method can also include controlling a transfer of music content items from the server to individual remote user music devices according to the collection map associated with the relevant user account.

### TECHNICAL FIELD

The present disclosure relates generally to the organization and distribution of digital media content. More specifically, inventions relate to systems and methods for organization and/or distribution of music content implemented through a computing cloud.

### BACKGROUND

The term “content delivery” is frequently used to describe the delivery of different types of digital media (or “content”) including but not limited to digital audio, digital video, software, games, documents etc. over a delivery medium such as the Internet.

In the distinct field of digital music content, including for instance music audio and music video, and related music content, a number of music delivery applications and services have been deployed across a wide variety of platforms to cater for different needs. For example, “iTunes” is a well-known proprietary digital media application produced by Apple Inc. used for playing and organizing digital music and video files stored on a user's desktop computer, or other suitable electronic device.

Many of these types of digital media applications also enable users to purchase and download music, music videos, television shows, applications, games, audio-books, various podcasts, feature length films. The above-mentioned applications and services generally enable users to organize and catalogue content stored on their various electronic devices.

However, none of the above technologies allow personal collections of music content to be stored, organized and distributed through an online environment, rather than on individual devices (desktop computers, laptops, media players etc.).

### SUMMARY

According to embodiments of the present disclosure, there are provided several apparatus, methods and computer readable media as set out in the appended claims.

In one aspect, the disclosure relates to a music device management apparatus configured to manage music content collections each of which is held across a plurality of remote user music devices associated with an account holder. The apparatus includes a music content item store and a collection map store that includes a plurality of collection maps each indicating how music content items making up a music content item collection associated with a user account are held across a plurality of music devices associated with the user account. The apparatus also includes a user music device interface arranged to provide connections between the music device management apparatus and a plurality of remote user music devices, and a management processor operable to control transfer of music content items from the music device management apparatus to individual remote user music devices according to the collection map associated with the relevant user account.

The apparatus, in some configurations, can include an analysis module operable to connect to individual remote devices belonging to a particular user via said user music device interface and configured to probe music content items residing on individual remote devices and to return results to build a collection map for the user.

In some instances, the apparatus also includes management rules defining transfers of music content items from the apparatus to a particular user music device. The management rules can implement a transfer of a new music content item to a particular device, implement movement of an existing content item between devices belonging to the user, and implement digital rights management.

In some instances, the user music device interface includes a collection management interface and the management rules implement user manipulations applied to the collection via the collection management interface. In addition, the management rules can implement automatic synchronisation actions between the collection map and one or more user music devices.

In some configurations, the apparatus includes a content analysis processor configured to probe user music devices to retrieve music consumption behaviour data recorded thereon. The content analysis processor can be connected to record results to said management rules for use in automatic synchronisation activities. The results can be recorded in a format suitable for electronic supply to third parties and, in some cases, for determining royalty splits. In addition, in some configurations, the apparatus is operable to update the status of a user on a social networking website in response to the user consuming a music content item.

The apparatus, can also include, a content distribution processor operable to control content consumption and or sharing rights among users. In some situations, distribution rules define one or more of: content consumption and sharing rights, by a user. Also, the distribution rules can implement one or more of: perpetual consumption rights of a particular music content item; temporary consumption rights of a particular music content item; consumption mode of a particular content item. In addition, the distribution rules can implement temporary consumption rights by defining an availability time period or number of plays (“consumption durations”) applying to a particular content item. Further, the distribution rules can define a consumption mode such as one or more of: downloading; streaming; and sharing.

In some cases, the user music device interface includes a collection management interface capable of presenting a GUI to users. The GUI facilitates moving of grouped user music content items between different devices on the map by means of dragging a representative icon.

The apparatus can also include a file format conversion module. The apparatus can also include data on different types of user music devices such that the data can be referred to ahead of the management processor transferring music content items to a particular device. In some cases, the data on different types of user music device includes one or more of: memory capacity; file formats supported; manufacturer; and model.

The apparatus can also include user account information including rewritable permissions data. In some instances, the permissions data records user permissions relating to music content consumption durations, records user permissions relating to music content consumption modes, and records user permissions relating to music content consumption duration or modes by content item. Also, the permissions data can record user permissions relating to music content consumption duration or modes by user.

The apparatus can include a retail module operable to present an interface through which individual users can purchase music content items. In some cases, the apparatus can also include a sharing module operable to facilitate sharing of music content items between different users. Together the retail and sharing module supports transactions of music content items between users.

In some cases, the retail module connects to music content items originating from a plurality of different commercial sources. In such cases, music content items from two or more of said different commercial sources can be presented via interfaces with a different look and feel. In addition, the sharing module can be configurable to allow sharing by one or more of: downloads; streams; broadcasts; Web publishing.

The apparatus can also include a storage area that provides a plurality of personalised storage areas each associated with a user account. Also, in some instances, the apparatus also includes digital watermarking module operable to mark a user content item ahead of distribution to a device associated with a user account.

The apparatus can also include a security code operable to detect and block non-feasible logins attributable to a single user login identity.

In some configurations, the apparatus includes a promotional module. In some instances, the promotional module is operable to grant music content item access permissions by user. The promotional module can also grant music content item access permissions by music content item or by user and set consumption duration and or mode by music content item. Further, the promotional module configurable to set consumption duration and or mode by user.

The apparatus, can also include an audit module. Functionality provided by the audit module includes the ability to observe and record one or more of: user purchasing activity; user responses to promotions; and user sharing behaviour. In addition, the audit module can generate electronic questions for prompting direct user responses. The responses can be used in performing automatic synchronisation taking into account data from one or more of an analysis module and an audit module.

In some case, the apparatus also includes a user account configured to record entitlements accrued by one or more of: purchase activity; promotional benefits; earned by usage; and presented as a gift by another user. Sometimes, the apparatus also includes a personal storage area associated with a user account and at least a portion of that personal storage area is private. Another portion of the personal storage area is also accessible to third parties via the Internet.

In various situations, the transfer of a music content item by the music device management apparatus to a remote user music device implements part of a move or a copy of a content item between devices according to a collection map associated with the relevant user account.

In some cases, the management processor is further operable to block access or to cause deletion of a music content item on a remote user music device according to the collection map and associated user account. For example, this can be used to halt a temporary availability of downloads. Alternatively, or in addition, temporary availability can be halted by re-writing a user permission, say in the case of streaming access to a content item.

In another aspect, the disclosure is directed to a music content distribution apparatus configured to electronically distribute music content items for consumption on a plurality of remote user music devices, The apparatus includes a music content store holding a plurality of music content items for electronic distribution among a population of remote user devices and music content distribution rules including electronic distribution rules defining consumption duration attributes by music content item, wherein consumption duration includes temporary consumption availability on an end user device.

The apparatus also includes a user music device interface through which user music content items can be transferred to said devices and a music content distribution processor operable to control distribution to a plurality of remote user devices according to duration attributes applying within said music content distribution rules.

In another aspect, the disclosure is directed to a method of managing music content collections each of which is held across a plurality of remote user music devices associated with an account holder. The method storing a plurality of collection maps on a server in communication with a network and controlling a transfer of music content items from the server to individual remote user music devices according to the collection map associated with the relevant user account. Each collection map indicating how music content items making up a music content item collection associated with a user account are held across a plurality of music devices associated with the user account.

In another aspect, the disclosure is directed to a method of distributing media content through a network. The method can include storing a media content item at a server in communication with the network, executing a one or more distribution rules, and transferring the media content item to the requesting user device. The distribution rules can be executed upon receipt of a request from a user device in communication with the server through the network. The distribution rules can apply a consumption duration attribute to the media content item that defines a limited consumption availability for that media content item.

Other concepts relate to unique software for implementing methods described herein. A software product, in accord with this concept, includes at least one machine readable medium and information carried by the medium. The information carried by the medium may be executable program code.

In one aspect, the disclosure is directed to an article of manufacture. The article includes a machine readable storage medium and executable program instructions embodied in the machine readable storage medium that when executed by a programmable system causes the system to perform functions that manage music content collections each of which is held across a plurality of remote user music devices associated with an account holder. The functions include storing a plurality of collection maps on a server in communication with a network, each collection map indicating how music content items making up a music content item collection associated with a user account are held across a plurality of music devices associated with the user account and controlling a transfer of music content items from the server to individual remote user music devices according to the collection map associated with the relevant user account.

In another aspect, the disclosure features an article of manufacture that includes a machine readable storage medium and executable program instructions embodied in the machine readable storage medium that when executed by a programmable system causes the system to perform functions that distribute media content through a network. The functions include storing a media content item at a server in communication with the network, executing a one or more distribution rules upon request from a user device in communication with the server through the network, the one or more distribution rules applying a consumption duration attribute to the media content item that defines a limited consumption availability for that media content item; and transferring the media content item to the requesting user device.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an example of a media content management system 1 according to an embodiment of the present disclosure.

FIG. 2 illustrates more detail of a music content management computer 10 as shown in FIG. 1.

FIG. 3 shows an example of data stored in a typical user account.

FIG. 4 shows an example of data stored in the retail module.

FIG. 5 shows an example of a method of managing media content.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to systems, method, and articles of manufacture for performing the various methods disclosed. Embodiments described herein reduce, in some instances, the processing load experience by a processor when compared to other systems. This reduction in load frees the processing resources to perform other tasks.

Reference now is made in detail to the examples illustrated in the accompanying drawings and discussed below. Those skilled in the art will appreciate that while this disclosure describes what is considered to be the best mode and, where appropriate, other modes of performing the invention, the invention should not be limited to the specific configurations and methods disclosed in this description of the preferred embodiment.

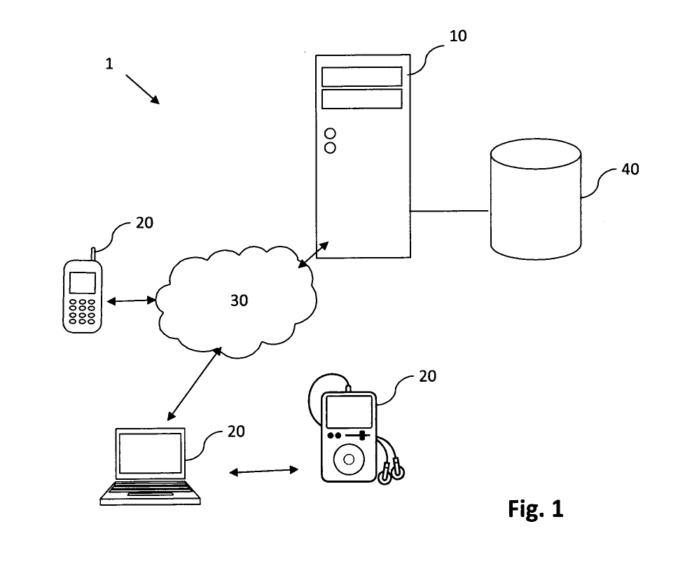

FIG. 1 illustrates an example of a music content management system 1 according to an embodiment of the present invention. In this embodiment the preferred content comprises music content, not necessarily exclusively. The music content management system 1 comprises: a music content management computer 10, with at least one data storage device 40, in communication with one or more user music devices 20 via a suitable network 30, such as the internet. Examples of user devices include but are not limited to: desktop and laptop computers, mobile phones, PDAs and media players. Typically, each user has a plurality of different music devices, capable of connecting to the computer 10 by wired and or wireless connection means.

In practice, a given user may have music devices that can play music content and others that simply store it, either type can access a LAN or similar local network which is itself connectable to the internet via a suitable gateway device. This includes devices such as mobile telephones that are connectable directly to the internet. A user's collection of devices typically includes a plurality of player devices and possibly additional devices capable of local storage of content items.

According to one embodiment, the one or more user devices 20 is capable of internet communication and, as such, is equipped with the necessary components to access the internet, wirelessly or otherwise. A browser application on a user device can enable direct interaction with the music content management computer 10, for example by means of presenting a graphical user interface to the user. However, it should be noted that it is not necessary for every user device to have internet connection capabilities for the purposes of the present invention. For instance, where a user has more than one user device in their possession, it may be necessary that only one of those user devices has access to the music content management computer 10 via the internet 30. User devices without internet access can then connect to the user device with internet access (e.g. via a suitable cable or other wireless communication means) in order to interface with the music content management system 1. This type of operation is referred to as “device sharing” according to embodiments of the present invention.

Thus, media players without web browsing or internet capabilities can be ‘seen’ by the content management computer 10 once suitably connected to a user device with internet capability. More sophisticated media players may be able to receive client software which enables direct interaction with the content management computer 10, once a connection has been established as will be explained hereinafter.

According to one example, the music content management system 1 is a “cloud” system capable of functioning as a device manager, among other things. A cloud system in the context of the present disclosure is intended to refer to internet (“cloud”) based development and use of computer technology. In other words, it provides music content and related services delivered through online data centers and built on remote computer servers. The music content and related services provided are accessible anywhere in the world via internet 30, with the content management computer system 10 being accessible to all registered users.

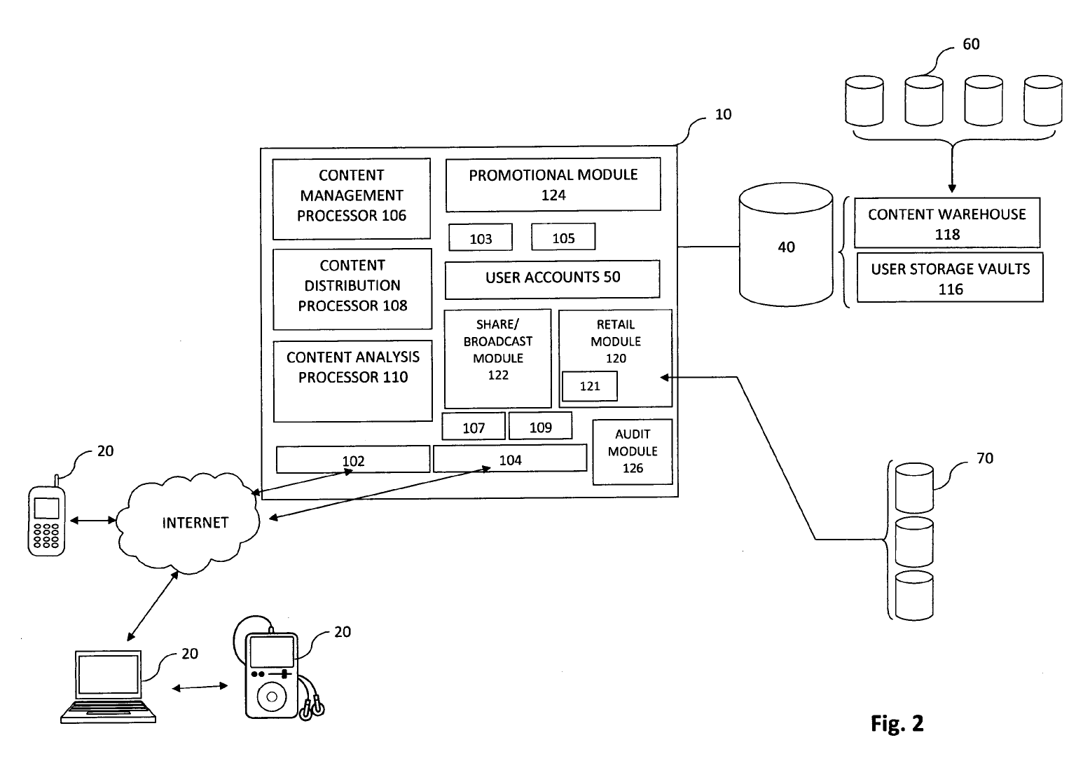

FIG. 2 illustrates more detail of the music content management computer 10. The content management computer 10 comprises: a plurality of user accounts 50; a web interface 102; an application programming interface (API) 104; a content management processor 106; a content distribution processor 108; a content analysis processor 110; and at least one data storage device 40. In the disclosed embodiment each user account 50 is associated with corresponding content in the content warehouse 118 as well as a user storage vault (area) 116, both of which are provided in this example on storage device 40.

According to one embodiment, the music content management computer 10 further comprises a retail module 120 for online sales administration, a sharing/broadcast module 122, a promotional module 124 and an audit module 126, as explained in more detail below.

The web interface 102 provides front-end access to the content management computer 10 via a web browser interface. The front end access provides a collection management interface as well as device access for the purpose of playing music content. General technologies for such web-based user interfaces are well known in the art for accepting various user inputs, and provide output by generating web pages which are transmitted via the Internet and viewed by the user using a web browser program such as Mozilla Firefox or Microsoft Internet Explorer or mobile browser programs well known in the art.

According to embodiments of the present invention, the web interface 102 has at least two functions: firstly, to provide normal web content such as web-pages accessible through web browsers on user devices 20; and secondly, to receive content from and transmit content to user devices 20 by a suitable protocol such as HTTP, FTP or otherwise. Typically, a user device 20 connects to the content management computer 10, either through a normal web browser or through client software residing on user device 20.

The application programming interface (API) 104 is operable to integrate the music content management system 10 with existing media applications such as iTunes, Winamp and Windows Media Player, as well as online retail stores, such that devices running these applications and services can connect to the content management computer 10 and integrate with its services. Thus, the content management computer 10 can “see” the content of any connected device supported by its API. Likewise, the content analysis processor can probe the content residing on user music devices.

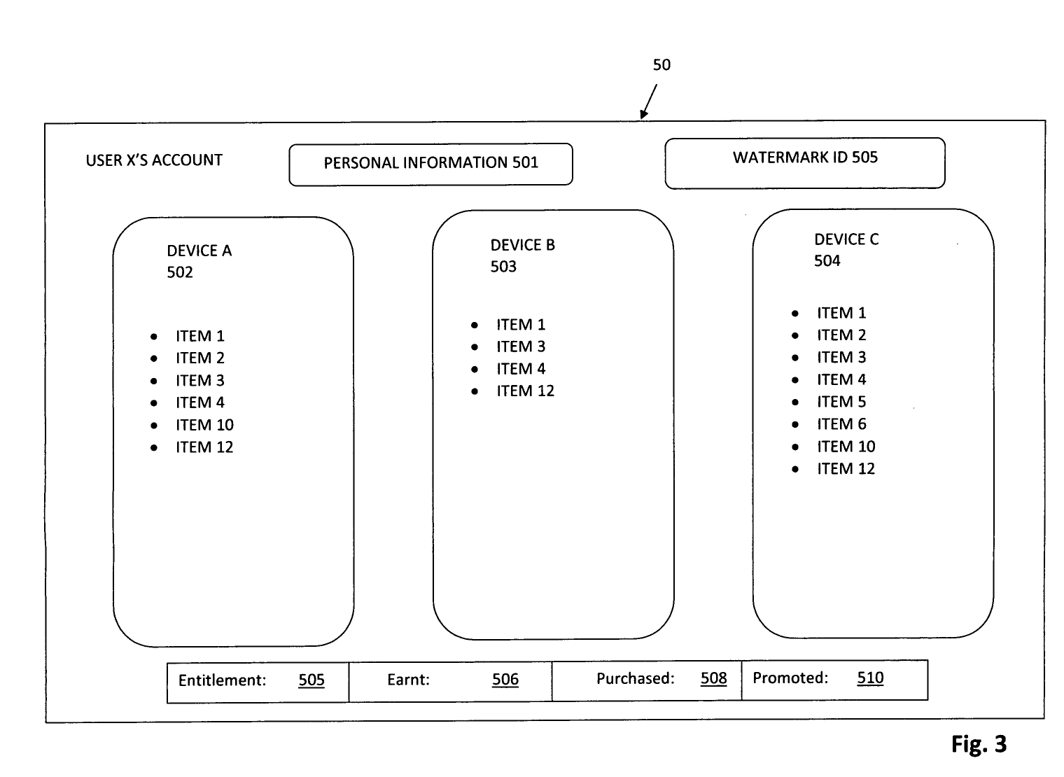

The content management computer 10 comprises a suite of user accounts 50 setup for holding gathered information using known techniques e.g. filling in a registration form via the internet. Each user account 50 also has a collection map representing the particular user's entire music content collection, and also how music content is spread across individual ones of the user's music devices 20. The collection map is generated on initial registration when the computer 10 processes the user's music content collection by probing the user's various devices and is described hereinafter with reference to FIG. 3. The collection map may be expanded later when the user connects using a different device. Thus the complete map including all relevant devices may be constructed over time. Each user account also has an associated user storage area 116

The computer 10 thus stores a record of music content held by user. This online collection map is a representation of a user's entire music collection. Where user content listed in the collection map is recognized as commercially available content, the map merely includes a reference to the relevant content item in the content warehouse 118. In this way, users can also freely access all of their recognized content from any user device 20 by logging into their user account 50 and requesting the content. In this context, a user's collection map can include “recognized” or “unrecognized” content, where “unrecognized” refers to non-public content and/or a user's self-generated content. A collection map usually refers to such content in the user's personal storage vault 116. For example, the user may have recordings of their own songs, videos etc. that they wish to upload to their user storage vault 116. It may also refer to content devoid of metadata, for instance, music tracks without artist/title information stored on the user device 20. Once this content has been uploaded to user storage vault 116, the user can freely access their own content from any user device 20 by logging into their user account 50 and requesting the content.

Whilst the collections of individual users are generally private, at least a portion of a user's collection may be flagged for publication to other users or subsets of users. Individual users can use the interface to the computer 10 to build personal areas of content on their user storage vault 116. Such areas may have content for download, content for streaming, editorialisation, webpages, bulletin boards or walls or other communication means. Having built such an area (referred to herein as “MYPODPAGE ”) it may be made public or it may be made accessible to particular groups or individuals. In this regard, access rights may be set permanently (until manually reset) or temporarily or subject to particular requirements or limitations.

Hence, according to embodiments of the invention, users are able to store all of their digital content in a single place online and are able to download or stream content to any device (commercial restrictions permitting).

FIG. 3 shows an example of data stored in association with a typical user account 50. According to this example, X′s user account comprises a unique account ID. It also includes personal information 501 such as username, password, address, age and other related data. A user account 50 may also have subscription information for mailing lists e.g. so that the user can receive alerts on a favorite band, TV show, director, or specific pieces of content. In addition, X′s user account further comprises device content listing information 502-504. Device content listing information, typically in the form of a metadata list as mentioned above, is a list of the user's content items by user device 20. This record (also referred to herein as “collection map”) reflects the status at the last synchronization by the content management computer 10 with one or more user music devices 20, unless the collection has since been organized manually via the collection management interface.

Between synchronizations, the user may add new music content items to any one of the user's music devices 20, remove content items from any one of the user's music devices 20 and or move content items between any two of the user's music devices 20. All such changes in the collection will be captured during the next synchronization process, and the collection map will be updated accordingly.

While logged on, a user can make changes to a collection (additions, deletions or moves) at global or at a device level. In one embodiment, any such changes made through the collection management interface are reflected through to the devices during the next synchronization process. Hence, synchronizations can be configured to be bidirectional (reflect changes made at device level on the collection map and also push changes on the collection map down to the user music devices) or unidirectional (either (i) updating the collection map only in terms of changes detected at the user music devices or (ii) push changes at he collection map down to the user music devices only). Changes at device level are implemented when the relevant device logs on, and this may be at the same time or after the change is made at the management computer.

Following the example shown in FIG. 3, for instance, device A could be user X′s laptop, device B could be user X′s media player and device C could be user X′s mobile phone. Each of the items (item 1, item 2, etc.) represent individual items of content such as mp3 files, videos and such like. Often times, a content item designed to be played is available on the local memory of the device then available to the user. Where this is not the case, it can be moved there on-demand or ahead of time based on the synchronization feature or a configurable transfer schedule. In one embodiment, one or more content items can be removed to an end user device according to one or more playlists associated with that device. A user can access any content item in the collection map from anywhere by one or more of direct play (from local memory), download or streaming, subject to user music device capabilities.

The online content management computer 10 can thus be used to organize and distribute music content between a user's various devices from anywhere in the world. Music content from a user's own collection (including personal vault 116) can be distributed to any one of that user's devices or to a peer device (including a vault) belonging to another user. Embodiments enabling a user to configure transfers from or access to their own area may therefore also be used as a content sharing and/or broadcast platform between users, as will be explained further below.

According to one embodiment, the content management computer 10 further comprises a conversion module 103 operable to convert content into different formats suitable for different types of devices.

The disclosed computer 10 also comprises a fingerprinting module 105 implementing for example commercial audio and video fingerprinting technologies. Such known technologies can analyze sample content files or a portion thereof. The fingerprinting module is configured to verify that music content items within an individual user's collection are indeed proper content files (i .e. the actual audio or video files they appear to be from the meta data) and/or determine whether or not each content item is authentic. In preferred embodiments, the fingerprinting module can interpret digital watermarks and other known types of DRM to determine origin, authenticity and/or aspects relating to purchase circumstances, to establish whether or not the music content item is an illegal copy.

The fingerprinting module 105 typically processes a user's collection on initial registration with the computer 10 but also processes changes to the collection as music content items are added, particularly where tracks are added other than through the retail module. Usually unrecognized content will undergo a recognition process (e.g. via CDDB from Gracenote or an equivalent over the Internet) such that “unrecognized” content becomes “recognized” and the computer 10 records the relevant metadata describing what it is in the collection map.

In the disclosed embodiment, a user's collection of music content stored online can be added to from existing music content stored on user devices 20 and/or new music content purchased/acquired via the retail module 120 or the promotional module 124 or shared from other users. In the event a user buys a new physical format music product, such as a CD or DVD, and uploads its music content on to a music device 20, such as the user's iPod library, then this newly acquired music content will be identified and registered in the user's online music collection next time the user connects to the computer 10.

According to one embodiment, content from the store 40 is configurable to be streamed in real-time to one or more compatible user devices. According to one embodiment, the storage device 40 may also comprise a public area containing content freely accessible to all users with an account. Some or all of this content may be available on a restricted or limited usage basis, and its consumption in terms of purchase and usage (including sharing) may be monitored according to the mechanisms described hereinafter.

The music content warehouse 118 is another storage space provided, in this example, on storage device 40. The content warehouse provides an online destination for housing all commercially available content, for example incorporating downloads and streams of music tracks (singles and albums), videos, promotions, features. Whereas, unique user pages and editorial are typically held in the user vault area 116.

The music content warehouse 118 may host and provide users with media organized by artist or themes, for example all media available from particular artists, such as rare content (unpublished demo sessions, b-sides), video diaries, ‘Before they were famous . . . ’ content including early gig recordings, video footage, photos, etc. The content warehouse 118 also stores web-pages and other content necessary to provide the herein disclosed services to users.

According to one embodiment, the content warehouse 118 may be populated, at least in part, by an external system and/or service, for instance, through web interface 102, API 104 or other suitable interface. For example, the content warehouse 118 may receive content from or link to another supplier database or a plurality of databases. In one embodiment the content warehouse is connected to remote databases administered by media publishers, such as record labels and film studios. Referring again to FIG. 2, the optional databases 60 in this example represent the remote content databases of several record labels. However, it will be clear to the skilled person that any number of external databases from any type of content distributor may be used to populate the music content warehouse 118.

The content management processor 106 is operable to manage individual music content collections across a plurality of devices belonging to the relevant individual. It can access a set of rules 107 defining how content should be managed over the different devices of each user. A portion of the rule set 107 is configurable by the user, for example via a collection management GUI, and a portion of the rule set 107 is configurable by an administrator. The term “administrator” herein is intended to include human administrators and/or computers. In certain embodiments, the rules 107 are at least in part defined by other software components of the system, such as the content analysis processor 110 which can set up smart synchronization rules by device according to the analysis of music consumption.

In use, when a user device 20, such as a mobile phone, desktop/laptop computer and/or media player, connects to the content management computer 10 via the web interface 102 (or API 104), the content management processor 106 registers the device content with the content distribution processor 108. In other words, any items of content stored (or more preferably metadata indications of the content stored) in the internal memory of user device 20 may be transmitted to the content management computer 10 and stored in a register for future use. The result of this registration is a map of the user's entire collection by device, as illustrated above with reference to FIG. 3.

According to one example, generation of the map involves the music content items themselves being transmitted from user device(s) 20 to the content management computer 10. This enables fingerprinting processes to be run on the computer 10. However, according to preferred embodiments, content items themselves are not transmitted to the content management computer 10 and instead one or more metadata files indicating content items stored on user device 20 are transmitted to the content management computer 10 and the content items themselves are sourced from elsewhere when they are required, e.g. the storage device 40, or an external data store, when requested by the user. To this effect, for example, if a user has media item “X” on a first device (say a music track on a mobile phone) it may not be desirable to transmit a copy of the file itself for bandwidth usage or rights management reasons. Instead, a set of metadata files describing commercially available tracks held on the first user device is generated by a web-based application and associated with the user's account 50. In this case, the content management processor 106 can deploy a client fingerprinting application (or engage one already residing on a user music device) in order to check authenticity and/or DRM aspects of the user's collection each time new music content items are detected.

The music content metadata set making up the “by device collection map” according to FIG. 3 is held in computer 10, whereas the corresponding music content files are held in the store 40. The entire collection map is built up as each of the user's devices connects and it's contents are registered with computer 10.

Thereafter, if the same user logs into their account from a second device (such as a laptop computer), which does not contain media item “X”, a copy of that item can be sourced from the storage device 40 and transmitted to the second user device. In this way content items belonging to a particular user can be legitimately distributed (by download and/or streaming) among devices owned by that user. Various automatic synchronizations may be defined at least in part within the rules 107.

According to one embodiment, when a user device 20 connects to the content management computer 10 via web interface 102 and/or API 104, the user's existing collection stored on the user device 20 is ‘synchronized’ with the same user's online account 50. Hence, any content items present on device(s) 20 that do not already appear in the user's collection map (see FIG. 3) may be registered in online user storage vault 116 so that the user is able to download or stream the content at a later time, and if desired to a different user device associated with their account if they wish (rules permitting). Preferably, the online storage space in each user storage vault 116 is very large or unlimited, however, according to one example, the online storage space is limited to a predetermined amount and/or governed by a ‘fair use policy’. Further, new content online is synchronized to the devices it is allocated to (if any) on the user account record. In this way, the content management computer can facilitate the movement of music content into the online collection map and from there between different devices belonging to the user. This can be automatic according to the system rules or automatic according to users configurations, as well as a direct response to the user's organization through the collection management interface.

In operation, therefore, the content management processor 106 synchronizes content stored on the user's individual devices 20 with content registered in the collection map. According to one example, when a connection from a user device 20 is established or detected, the content management processor 106 automatically synchronizes content in the user storage vault 116 with the content in the internal memory of the user device 20. The system may allow the user to override automatic synchronization. In any event, synchronization involves transferring content (and/or metadata describing the content) out of the memory of the user device 20 into the user storage vault 116, transferring content (and/or metadata describing the content) from the user storage vault 116 to the internal memory of the user device 20, or a combination of the two.

According to one example, the content management processor 106 implements smart synchronization features written into the rules 107 by the content analysis processor 110. One example of a smart synchronization feature according to embodiment of the present invention is that the content management processor 106 only synchronizes items of content that have changed since the previous synchronization. In this way, internet bandwidth usage is kept to a minimum. Another example of a smart synchronization feature involves analysis of the user device 20 and/or analysis of the user's historic content usage or preferences, and provides customized content libraries, or individual items of content based thereon. For instance, if a user has a first device registered with the content management computer 10, and its content library is uploaded into the user storage vault 116, and then the user resisters a second device having a smaller memory, the content analysis processor 110 will generate a reduced library for the second device using the smart synchronization feature. To this effect, according to one example, the content management processor 106 accesses a database containing information about the most popular media players, mobile phones and other devices so it can readily ascertain technical information (such as memory size) about a new device once a connection is detected. This may be done by reconciling technical information in said database based on a detected device ID or, alternatively or in addition, the content management computer 10 may ‘probe’ the newly detected device to acquire information regarding its technical specifications directly from the device, for example the amount of total or remaining memory. A reduced library may comprise, for example, only the user's most popular tracks from an album, or content with smaller file sizes. According to one embodiment, proportions of total memory are allocated between different content categories (e.g. music, film) automatically or by a user. The smart synchronization feature may also filter out any content that cannot be played on the user device due to its hardware configuration for example videos cannot be played on audio-only devices.

Thus the content management processor 106 is operable to manage the sending and receiving of music content items within an individual user's music collection between different music devices 20 belonging to that user according to the rules 107, some of which may be set by the analysis module 110 to facilitate smart synchronization functions. The content management processor 106 may also restrict the total number of copies spread across a user's device collection. The content analysis processor 110, may also provide suggestions of content that the user may like or provide a playlist generated based on a known technology, and automatically add it to the user's device.

The content management processor 106 is also operable to connect to one or more external content information databases (not shown) such as CDDB/Gracenote etc. e.g. through API 104 in order to ascertain metadata describing items of content, by methods known in the art. The content management processor 106 is further operable to carry out a content referencing function. According to this feature, if content being recorded or manipulated already exists in the datastore 40 (for example when associated with another user or in a public storage area), the content management processor 106 can create a reference file to the existing content, rather than generating multiple copies of the content item. Hence, according to this feature, fewer files of unique content need to be stored on the content management computer 10, meaning that storage resources and bandwidth usage can be kept to a minimum. Therefore, no matter how many unique users add the same content item to their collection, the computer 10 is able to distribute the content item from the same source. Hence, according to one example, the content management processor 106 only maintains a single copy of the each unique content item and the need for copies is reduced through the use of mirror servers and load balancing software configured to spread the work-load between two or more servers.

It is not always necessary to transmit the content file itself to the second or further user device. However, it may be necessary or desirable to transmit the file itself , for example where item “X” is the user's own song and will not be available from elsewhere on the storage device 40 or an external database 60. On other occasions, digital rights management constraints may dictate that an item “X” is streamed to the second device.

The computer 10 may also be configured to implement file sharing rules among difference users. The processor 108 and rules 109 define such processes and control both the degree of file sharing permitted between users and the terms of file sharing between users. For example a user may be able to share content with other users if that user is granted the right to so do, pays for or earns the rights to do so, or if the recipient user agrees to purchase the content shared. In this regard, the rules 109 may be set by a system administrator and or other software components of the system, such as the retail module 120, the promotional module 124 and the sharing module 122. Most preferably, sharing rights emanating from the retail or promotional module are reported to the sharing module, which updates the rules 109.

The computer 10 supports sharing between users in a number of different ways. First, the users can set up a peer to peer sharing event or relationship. This mechanism enables direct sharing between user music devices of different users, without passing through the computer 10. By using local device 20 caches (memories) in such processes the burden on the computer 10 is reduced. However, set up of these sharing mechanisms are recorded in the computer 10 and all relevant sharing events are reported back to the computer 10. In this way, a user can select a content item to be shared with one or more peers, select an allowable mode of sharing (for example download or stream) and select a contact or group to share it with.

Second, the users can set up a sharing event or relationship in the interface so that it is recorded in the rules 109 and the distribution processor 108 performs the sharing at the next available opportunity. In this regard, the user interface with computer 10 enables a user to select a content item, select a mode of sharing (for example down load or stream) and select a contact or group of contacts to share with.

According to another sharing mechanism, users can place content to be shared in their personal vault area 116 and make it available. Availability may be set to “single contact”, “group” or “the public”, subject to sharing rights the user had in respect of the particular item of content, as reflected in the rules 109.

With all of the above mechanisms sharing uses (for example time availability or number of plays) and sharing mode may be restricted by the rules 109 as set by other modules. Any sharing occurring, irrespective of the mechanism, is monitored by the sharing module 122 as reported back to other modules of computer 10, as may be desired. For example, where a sharing event leads to a purchase, the sharing purchase audit trail is reported back to the audit module, which keeps logs of such events and statistics of such events. Alternatively, where a share event leads to purchase, the computer 10 can be configured such that both the share module 122 and the retail module 120 report back to the audit module 126. The audit module 126 can then match the events and record them in a log.

Users can a populate areas accessible to third parties with recommendations, editorializing and similar related content. Where user proliferation efforts such as sharing, recommendations, editorialisations and other similar activities, lead to transactions or appear to drive purchasing behavior in an attributable way, the audit module 126 can log this. Users may be categorized or identified as “super influences” and accordingly individual users may be rewarded with credits (MYMUSICMINUTES) on the system.

In one embodiment, multiple mirror servers are provided to offer multiple sources of the same information. This exemplary embodiment is advantageous in that it makes the present technology particularly storage efficient but yet provides large numbers of users with fast and reliable access to large numbers of downloads.

In one embodiment, a web interface or application is provided that enables users to graphically configure their own playlists and/or content libraries. According to one example, the interface displays content from the user storage vault 116 and/or warehouse 118, and the user device(s) 20. It further provides functionality that enables users to generate custom libraries from content tagging one or more categories, for instance genre, year of recording, tempo, artist, album, producer, writer, record label, hits etc. and assign each custom library to an icon. The assignment of the icon to the group may be automatic based on known search technology or it may be performed by a user according to user preferences. An icon representing the or each tagged category can then be dragged to the user device 20 graphically in order to copy over all relevant content items in a single action.

Currently, online music retailers only offer limited criteria with which to search tracks (such as “users also bought”, “other titles by this artist include” “other recordings of this song”). The content warehouse catalogues singles and albums in more detail (including: for example by producers who worked on the track/album; studio that the track/album was recorded in; writers who contributed to the track/album; engineers that worked on the track/album; country the track/album was recorded in etc). In certain embodiments, this will not only allow users to cross reference tracks using any one of those criteria but will also enable smart suggestion services. i.e. you are interested in “Album 1” and computer 10 tells you that “album two contains 70% of the same contributing parts” etc.

An exemplary list of searchable categories includes, without limitation:

Artist/Band member

Producer

Engineer

Technical Engineer

Drum Tech

Studio

Country the album was recorded in

Musicians

String Arrangements

Mix assistant

Protools Engineer

2nd mix Engineer

Masterer

Art Direction

Layout and Design

Photography

Band Photos

Artwork

A&r

A&r co-ordinator

Management

Agent

Lawyer

Business Manager

Record Label

Records released in the same week.

Records that sold the same amount

Records released in the same year.

There is also a function enabling grouping of individual categories together. For example: “find me the same creative team as this album” will include producer, engineer and musicians; or “find me the same tech team” will include protocols, drum tech etc; or “find me the same commercial team” will include label, manager lawyer etc.

The content distribution processor 108 is operable to manage the distribution of music content items to users according to retail rights, promotional rights, and sharing rights implemented by rules 109, defined by the retail module 120, the promotional module 124 and the sharing module 122.

In some circumstances, the distribution rules 109 may limit the number of copies and/or mode of consumption of a music content item that a user is permitted to consume. Such functions can be readily controlled by configurable rules 109 some of which may also be defined for example by a system administrator. For example, rules may define the number of copies and types of copies of a particular media item which may be generated by an individual user. To this effect, the content distribution processor 108 typically operates according to a plurality of predefined rule sets 109. For example, rules may be defined to prevent DRM-enabled files from being uploaded or download, or to prevent account sharing.

According to one example, the content management computer 10 uses security technologies such as one or more of: password control; DRM watermarking; and analysis of activity and usage. Such techniques can be used in this context to ensure that a) only an authorized user can access their account, b) any content consumed from the service is not shared illegally; and/or c) each account can only be used by one user or agreed account group member and therefore prevent password sharing abuse. According to one embodiment, the content distribution processor 108 also includes a security feature to ensure that any content currently stored on a user's device 20, and therefore being added to their online collection via synchronization, is authentic.

According to one example the content distribution processor 108 runs a known type of algorithm to prevent the same user ID(s) simultaneously logging into their account from more than one feasible user device 20 at any time. According to one example, predefined rule sets or algorithms may be configured to monitor the location of connecting user devices 20 and grant access based thereon, for instance such that a user can simultaneously log into their account from more than one device so long as the devices are on the same LAN and/or are not clearly in different geographic locations.

Certain modules, for example the retail and promotional modules, can set rules permitting a particular user's limited usage rights of predetermined music content items. For example the music content distribution processor 108 in combination with rules 109 can be configured to control one or more of: the number of consumptions; the length of time that content is available for consumption; and the addition of supported advertising. Such rights might also be granted by an administrator.

According to one embodiment, the synchronization process described above takes place in the background whenever a user device is able to establish a connection to the content management computer system 10. In effect synchronization involves a comparison and updating of the content listing information on all of the user devices 20 with the listing information in the user's account 50 stored on storage device 40, and vice versa. After successful synchronization, the content listing information on each user device 20 should be identical to that in the user's account 50.

Thus, according to certain to embodiments the behavior of the content distribution processor 108 is determined by referencing distribution rules 109 such that digital rights management (DRM), DRM-Free, limited consumption rights (in time or number of users) and/or advertising content are provided to individual users. In other words, content may only be consumed by a user if that user has permission to access that content. For instance, it is a feature of the embodiments of the present invention that users are able to participate in content delivery through multiple permission-based ‘packages’. In this context, a package is a type of account filter defined with predetermined access permissions. According to an example of a first package, a user is given permission to store existing device content online and to purchase DRM, non-DRM and advertising supported content. Preferably, the use of DRM content will be limited to a certain number of devices, whereas non-DRM content will not.

According to another example of a package, a user may pay a subscription fee (e.g. weekly, monthly, annually) that enables unlimited downloads or a predetermined number of downloads of DRM, non-DRM and advertising supported content. According to this example, access to content acquired through use of this package may be confined to the period during which the subscription is active. According to another example of a package, access permission may be given only to advertising supported content. It will be clear to the skilled person that different package configurations are possible and access permissions may be organized appropriately as required.

In one embodiment, the user account 50 also holds a reference to a digital watermark ID 505 associated with a given user. According to this feature, any time that content is downloaded to a user device 20 from the storage device 40 via the content distribution processor 108, the content will be encoded with a watermark ID associated with that user. This enables the content analysis processor 110 to track the usage and proliferation of a particular item of content. Alternatively, or in addition, a unique digital watermark can be applied to each content item (although not necessarily all its permitted copies).

The content analysis processor 110 is operable to analyze device level content collections, and register/upload analysis results to the content management computer 10. According to one embodiment, the content analysis processor 110 is configured to monitor usage of content collections both online and on user devices 20. As a result, the content analysis processor 110 is able to perform without limitation one or more of: analyze content collections and how they are used; split subscription payments and/or royalty payments for content generators based on which content is actually used (and not necessarily just which content is downloaded); suggest content collection variations for new devices based on a user's historical content collection habits; and enable users to share content amongst each other. The content usage data gathered by the content analysis processor 110 may be packaged such that it can be used by a 3rd party for the purposes of market research. For example, the analysis processor may probe which music content items are not being played, which ones are being skipped as well as where within the content item play out the skipping occurs.

This level of analysis can facilitate sophisticated royalty splitting arrangements. Subscription or other income can be split in proportion to consumption success. For example, royalty payouts may be split taking into account the numbers of actual play out events and/or streaming counts, not just the numbers of downloads per se.

Another function of the sharing/broadcast module 122 is to administrate aspects of user broadcasting. Thus, each user upon creation of a user account may be given opportunity to share, and/or broadcast, and/or editorialize, and/or own and/or control a unique media channel. According to one example, a user can setup their own playlist using content from one or more of their collection (including content within their user storage vault 116) and distribute it to other users via the content management computer 10. Playlists may comprise any one or more of content published by other artists, the user's own content, adverts, commentary or a mixture of any of these.

According to another feature, users can transact content items and/or other merchandise that can be distributed via the retail module 120 and/or shared, including via the user's individual broadcast channel. For the avoidance of doubt, users can sell to each other. This user driven transaction may be implemented in a number of ways. For example, a user may be granted right to share by way of a stream and the receiving user can view the stream with an option to click to purchase.

The retail module 120 thus enables users to purchase and sell content. According to one example, the retail module serves content from an online shop, which may be integrated with the content management computer 10 or sourced externally via API 104. Referring again to FIG. 2, the databases 70 represent the optional databases of external online retail stores such as Amazon and Play.com.

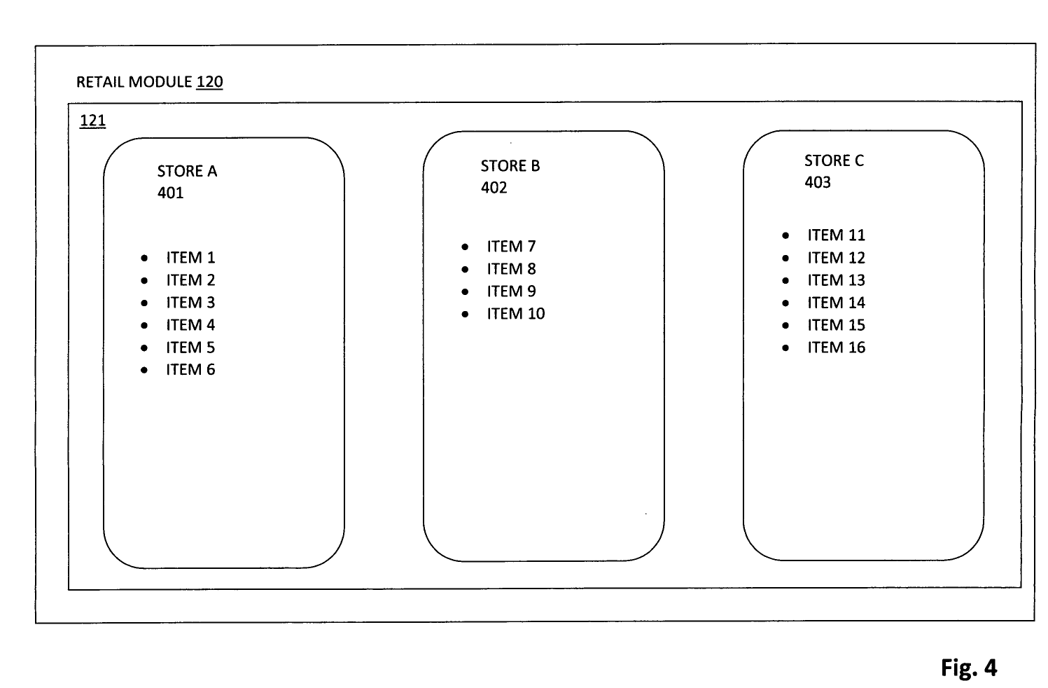

FIG. 4 shows more detail of one embodiment of the retail module 120. The retail module 120 houses a data file 121 comprising a list of all content, wherein each item represents an individual content item available for purchase (download and/or stream) from content warehouse 118 and/or external stores 70. In the example shown, separate sub-files are maintained for each store. For example, a first store (“Store A”) could be hosted on the content management computer 10, whereas second (“Store B”) and third stores (“Store C”) could be external stores managed by a third party but integrated with the system. Once a user makes a request to purchase a particular item of content, whether for downloading or streaming, the content can be provided to the user device 20 via the internet from a suitable source using the data file 121.

In one embodiment, the retail module presents a unified interface to users in the sense that they cannot tell the material consumption may be sourced from different stores. In another embodiment, the retail module presents to the user different interfaces (and possibly also a different look or feel) in respect of different stores. In certain embodiments, the retail offering is not limited to digital music content. For example, there may also be offered a range of physical products or services, such as one or more of: physical music formats (for example CDs or DVDs or the like); other physical products or merchandise; live events by streaming or by attendance at ticketed events.

Thus, according to embodiments of the invention, a user may purchase, earn or be granted credits for music content and therefore be able to access content with the full functionality of the system. In one example, users can purchase downloading and streaming credits which can be used for a variety of purposes. Such credits entitle a user or example download, stream, share (via streaming or download or web access) content items. As explained hereinbefore, certain music content access rights may be limited, that is limited in time and or according to the number of uses/consumptions. Mode of use may for example be a download; a play or a sharing event.

For instance, a user can use download credit to purchase content and download it to their user device. Downloaded content may be limited in terms of how many times, or for what length of time (e.g. 1 week) it can be played or it may be unlimited in this regard. Users may use streaming credit to stream a track to a user device a predetermined number of times or for a certain amount of time. Alternatively, users may use both download and streaming credit to provide content to other user's accounts. For example, a user may give credit to a friend as a gift or may use the credit to send a specific item of content to another user. For instance, a user could purchase 10 streaming credits for a particular song and send the song to 10 different friends so they can play it and decide if they wish to purchase it.

The retail module 120 can be configured to enable a user to act as a retailer and sell content from the content warehouse 118 or external retail source through a personal channel (for example a web page). In this example, a user may be given a reward or a share in the profits of any sales directly attributable to that user, whether those sales relate to streams or downloads. According to one example, the retail module 120 manages a loyalty scheme where MusicMinutes™ or some other credit reward can be earned through generating advertising revenue for content, introducing friends, spending time online and, for other monitorable activities, which credits can be spent on purchasing or streaming content, gift vouchers or physical products.

In the disclosed embodiment, the retail module 120 also enables users to sell their own content to other users for downloading and/or streaming.

According to one embodiment, the promotional module 124, optionally working in conjunction with one or more of the retail and sharing modules, can perform controlled and monitored marketing initiatives. The promotional module 124 enables campaigns to be set up and administrated by system users and/or the system administrators. In one embodiment, the promotional module 124 has an API interface enabling content publishers and or distributors to configure campaigns directly on the content management computer 10. Most typically, the campaigns will be based around advertising promotions setup in order to drive certain items of content, however other campaigns may be setup as required. Campaigns are generally governed by specific rules, which may be defined according to any category. For example, a campaign could be configured such that any user who purchases a particular single is presented with the opportunity to try the rest of the album for free, for example either by streaming or downloading for a limited number of plays (using a suitable DRM technique) before they decide if they want to buy. Another exemplary type of campaign is “try before you buy”, according to which users are provided with temporary access, and possibly also with sharing credits.

Campaigns could be defined to target types of user, for instance and without limitation: all registered users; users of a particular class, for instance all rock fans, or all users in a certain age group; users having particular items of content, or items in particular content categories; users with particular interests etc. Recording such types of information in association with user accounts enables targeted content delivery and campaigns.

According to one embodiment, a graphical user interface displays to a user any tracks that the user has tried out in the past but does not yet own. For instance, songs the user has tried but not yet purchased appear in a “grayed out” format. The user may then be further prompted to buy the content, either for streaming or for download. According to one feature, users are given the option to “try until you buy” content. This means that, after a user has purchased an item of content for streaming a predetermined number of times, or for download for a certain time, the user is automatically given access to download the content or stream it an unlimited number of times without incurring further charges.

The audit module 126 monitors one or more of purchasing, promotional response and sharing behaviors. This is achieved for example by monitoring the retail module 120 and or share/broadcast module 122, and optionally also receiving updates determined by the analysis processor 110. According to one example, the audit module monitors free play and trial content behavior distributed as part of campaigns, setup and controlled using the promotional module 124. In one embodiment, the audit module monitors purchase uptake % of individual shared content. The audit module can be configured to track how content is proliferated amongst users. For example, if a user streams a content item to 10 friends, the audit module 126 will track and record the behavior of those friends, for instance, which of those friends purchased the item of content (or a related item), which streamed it to other friends, which didn't do anything related to the content once they had listened to it etc. The audit module 126 can also measures relative popularity of content, for instance, songs on an album to help decide next single launch.

The audit module may also generate questionnaires or other user feedback prompts to ascertain conscious levels of likes and dislikes of individual content items. Such information may be compared with the monitored purchase, promotional response and sharing observations, in order to determine differences between perceived and actual likes and dislikes.

In one embodiment, the promotional module 124 receives data back from the audit module 126 which enables campaigns to be adjusted based on the data. This may be done automatically by the promotional module 124 or manually by administrators. Otherwise, or in addition, data from the audit module may be exported to third parties independently.

In summary, content management processor 106 is operable to generate and administer a plurality of on-demand libraries, each of which can be associated with a user account 50. Each such library contains data defining content of a user but not necessarily the content itself. According to one example, the on-demand library is a metadata file (for instance coded in XML format) comprising certain items of content currently associated with an individual user. The content represented by the metadata file can be streamed from the storage device 40 to the user device 20 on demand, without downloading entire libraries of content, thus saving memory, download time and bandwidth usage.

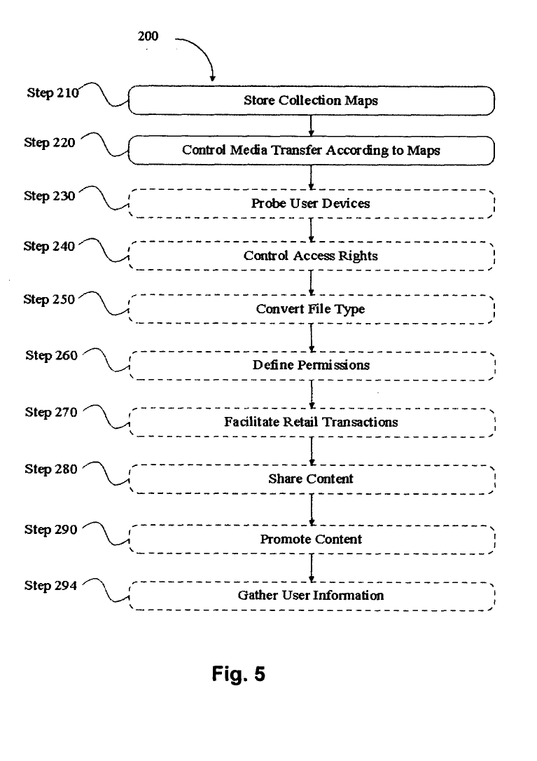

With reference to FIG. 5, a method 200 of managing media content is shown and described. The method 200 includes storing (step 210) collection maps at a computer (e.g., server) such as the music content management computer 10 of FIG. 1 and FIG. 2. The collection maps, as described above, indicate how music content items making up a music content item collection that is associate with a user account are held across a plurality of music devices associated with a user's account.

The collection map, in some examples, represents the particular user's entire music content collection, and also how music content is spread across individual ones of the user's music devices 20. The collection map is generated on initial registration when the computer 10 processes the user's music content collection by probing the user's various devices as previously described. That is, the collection maps contain content listing information, typically in the form of a metadata list as mentioned above, which is a list of the user's content items by user device 20.

The method 200 includes, in one embodiment, controlling (step 220) the transfer of music content items from the computer 10 to individual remote user music devices 20 according to the collection map associated with relevant user account. Said another way, the collection maps can define how and when music items are transferred among the music devices 20.

Various modules of the computer 10 previously described can aid in controlling the transfer of music content items from the computer. The content management processor 106, the content distribution processor 108, the content analysis processor 110, the promotional module 124, the share/broadcast module 122, and the retail module 120, alone or in various combinations can provide more or more types of transfer control. For example, management rules can be applied prior to transferring content.

Management rules can limit what types of music is transferred, when music is transferred, to which devices 20 music is transferred and the like. For example, management rules can dictate that only new music is transferred to specific devices 20. Other examples can include rules that transfer a music item between devices, rules that implement and apply digital rights managements procedures to music items, and manipulations of the collection received via one or more of the GUIs. Further, the management rules can implement various synchronization actions among the collection maps and the user devices 20.

The method 200 can also include probing, by the content analysis processor 110, the user devices 20 to retrieve music consumption behavior data that was recorded on the devices 20. This behavioral data can be used to update the management rules. For example, the management rules can be modified based on the music consumption behavior data to change which music items are synchronized.

The method 200, in some embodiments, includes controlling (step 240) access rights to music content among the users of the system 1. For example, the content distribution processor 108, can control which consumption and sharing rights are assigned to which users. This control can be realized using distribution rules that are similar to the management rules previously discussed. Further examples of distribution rules include, but are not limited to, implementing one or more of perpetual consumption rights of a particular music content item; temporary consumption rights of a particular music content item; consumption mode of a particular content item. Another example of a distribution rules includes implementing temporarily defining an availability time period or number of plays applying to a particular content item.

The method 200 can also include converting (step 250) music content among a plurality of file types. For example, if one of the music items is stored in an MP3 format the computer 10 can convert that the MP3 file into a .WAV or .AAC file depending on the parameters of one of the user devices 20.

As mentioned before, details about the specific user devices 20 can be stored in the user accounts 50 or other memory locations. Examples of device parameters that can be stored, include, but are not limited to memory capacity, file formats supported, manufacture, and model.

The method 200 can also include defining (step 260) as part of the user's account information. The permissions can be rewritable so that they can be changed from time to time. This feature provides flexibility and configurability for the system 1. Examples of the permissions can include, but are not limited to, music content consumption durations (e.g., number of plays, days of availability, etc.) and music content consumption modes (e.g., downloading, streaming, broadcasting, multicasting, etc.). The permissions can be associated with each content item, with each user, with each device 20, or various combinations thereof.

In some instances, the method 200 includes facilitating (step 270) retail transactions (e.g., buying, selling, and renting) of music content items. For example, retail module 120 can provide a GUI that acts a store front to allow the users of the system to buy, sell, rent, trade (i.e., barter) and promote various music content items. The retail module 120 can interface to other existing online retailers (e.g., iTunes, Napster, etc.) that provide content for purchase or rental. The GUI can take a different look and feel for each user of the system 1 and can be configurable using what is commonly referred to as skins. In the case where a user is selling content they created, the user can set a price of the music content or accept trades for the content. In addition, facilitating retail transactions can include implementing auctions or redeeming reward credits earned and associated with the users account.

When interfaced to third party content providers, facilitating (step 270) can also include determining revenue sharing percentages. That is, if the user purchases a music content item through system 1 the third party provider might receive a percentage of the revenue from the sale.

The method 200 can also include, in various instances, sharing (step 280) content with other users of the system 1. For example, each user can have a private storage area and a public storage as part of the user's storage vault. The private section can have access restrictions placed thereon to limit access. The public portion can be accessible by other users of the system 1. Music content that a user wishes to share or promote can be placed in this storage area for access by others. However, in order to prevent unauthorized copying the shared content may be limited in its ability to be transferred to other devices not associated with the user that is sharing the content. Said another way, the shared content may be limited to playback by the system 1 or may only be allowed to be streamed to a user device accessing the shared content.

In some instances, sharing can also include publishing the status of what the user is doing or listing too. Additionally, it can include sharing “playlists” or recent purchases with other users. In addition, the sharing module can interface with various third party social networking sites (e.g., Twitter, Facebook, and MySpace) to update those applications with the information from the system 1. For example, the sharing module 122 can automatically provide a ‘music status update’ that immediately posts what a user is listening to and where to indicated other users and social networking applications. These updates can occur regardless of which user device is being used to access the music content. Similar functionality can be used during the facilitating (step 270) of retail activities. For example, sharing (step 280) can include providing an updates such as: it is 12:45 pm: Craig is listening to Bring Your Daughter to the Slaughter by Iron Maiden on his iPod; it is 12:55 pm; Chris has just bought Lonely Lady by Joan Armatrading; and it is 12:59 pm: Justin is listening to Angel Face by Billy Fury on his laptop. In addition, a friend that receives the status update can be presented with a one click purchase option on any of these tracks with cooperation from the retail module 120.

In some case, the sharing module can implement a ‘follow my tracks’ feature where a user can advertise what they are listening too and allow other users to follow along by causing their user device 20 to mimic what is playing on the followed-user's device 20. Where the following user does not own the content item desired to be followed, the management computer can offer it for purchase and/or trail.

The method 200 can also include promoting (step 290) music content items. Promoting can include providing access control for certain music content of the system 1. For example, working in conjunction with other functionality previously described, a promotional campaign can be configured and executed. For example, if a publisher of music content desires, a campaign could be configured such that any user who purchased a particular single is presented with the opportunity to try the rest of the album for free, for example either by streaming or downloading for a limited number of plays (using a suitable DRM technique) before they decide if they want to buy.

The method 200 can also include gathering (step 294) information about a user of the system. This can include gathering information about the user during account set-up and subsequent account usage. Questions can be presented to the user during account set-up and response to these answers can be recorded and associated with the user for subsequent use. The questions can relate to demographic information of the users (e.g., age, location, sex, music preferences, income information, email address, mail address, and the like). This information can also be imported from other sources such as the before-mentioned social networking cites.

During account usage, for example, the user's activities can be monitored and some or all of those activities recorded and analyzed. This audit information can be used in marketing specific content to users (e.g., providing recommendations to the users about content that might be of interest to them) and for other purposes. The audit information can also be used to reward the user with entitlements (e.g., rewards and promotional benefits) for free content or reduced priced content. These entitlements can be stored in the user's account for redemption by the user at a later date. In addition, these entitlements can be transferred to other users of the system 1.

The transfer of music content to the devices 20 can occur via download, streaming, broadcasting and various combinations thereof. Specific details of these technologies are not described because they are known mechanisms for transferring data. In addition, music content items can be deleted from devices 20 and transferred therebetween by moving and copying entries in the content map of the user.

Although certain modules have been described as providing certain functionality, it should be appreciated the functionality of various modules can be combined in a single module. In addition, functionality of a single module can be further divided and split into multiple modules that together provide substantially similar functionality to that of the single module. Thus, the above-description should not be thought of as limiting the functionality described herein to a particular module.

In some instances, program aspects of the technology may be thought of as “products” or “articles of manufacture” typically in the form of executable code and/or associated data that is carried on or embodied in a type of machine readable medium or programmed computer. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another computer or processor. Thus, another type of media that may bear the software elements includes carriers such as optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the data aggregator, the customer communication system, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Hence, the embodiments of the present disclosure enable a user to have a secure and convenient method to access and consume content collections through any suitable device at any time. The embodiments of the present disclosure are further advantageous in that they create for the entertainment industry a direct to consumer relationship which has not existed to date.

Those skilled in the art will recognize that the invention has a broad range of applications in many different types of content distribution, and that the embodiments of the present invention described in this disclosure may take a wide range of modifications without departing from the inventive concept as defined in the appended claims.

1-145. (canceled)

146. A music device management apparatus configured to manage music content collections each of which is held across a plurality of remote user music devices associated with an account holder, comprising:
a music content item store;
a collection map store comprising a plurality of collection maps each indicating how music content items making up a music content item collection associated with a user account are held across a plurality of music devices associated with the user account;
a user music device interface arranged to provide connections between the music device management apparatus and a plurality of remote user music devices; and
a management processor operable to control transfer of music content items from the music device management apparatus to individual remote user music devices according to the collection map associated with the relevant user account.

147. Apparatus according to claim 146, comprising an analysis module operable to connect to individual remote devices belonging to a particular user via said user music device interface and configured to probe music content items residing on individual remote devices and to return results to build a collection map for the user.

148. Apparatus according to claim 146, further comprising management rules defining transfers of music content items from the apparatus to a particular user music device, wherein the management rules implement one or more of the group comprising:
a transfer of a new music content item to a particular device;
movement of an existing content item between devices belonging to the user;
digital rights management;
user manipulations applied to the collection via a collection management interface comprised in the music device interface; and
automatic synchronisation actions between the collection map and one or more user music devices.

149. Apparatus according to claim 146, further comprising a content analysis processor configured to probe user music devices to retrieve music consumption behaviour data recorded thereon.

150. Apparatus according to claim 146, comprising a content distribution processor operable to control content consumption and or sharing rights among users.

151. Apparatus according to claim 150, further comprising distribution rules defining one or more of: content consumption and sharing rights, by user.

152. Apparatus according to claim 146, wherein the user music device interface comprises a collection management interface capable of presenting a GUI to uses, wherein the GUI facilitates the moving of grouped user music content items between different devices on the map by means of dragging a representative icon.

153. Apparatus according to claim 146, further comprising user account information including rewritable permissions data.

154. Apparatus according to claim 153, wherein said permissions data records user permissions relating to one or more of the group comprising:
music content consumption durations;
music content consumption modes;
music content consumption duration or modes by content item; and
music content consumption duration or modes by user.

155. Apparatus according to claim 146, further comprising a sharing module operable to facilitate sharing of music content items between different users.

156. Apparatus according to claim 155 further comprising a retail module operable to present an interface through which individual users can purchase music content items and wherein said combination of retail and sharing module supports transactions of music content items between users.

157. Apparatus according claim 146, further comprising a digital watermarking module operable to mark a user content item ahead of distribution to a device associated with a user account.

158. Apparatus according to claim 146, further comprising a promotional module operable to perform one or more of:
granting music content item access permissions by music content item or by user;
setting consumption duration and or mode by music content item; and
setting consumption duration and or mode by user.

159. Apparatus according to claim 158, further comprising an audit module configured to observe and record one or more of: user purchasing activity; user responses to promotions; and user sharing behaviour which is preferably further operable to generate electronic questions for prompting direct user responses.

160. Apparatus according to claim 146, comprising a user account configured to record entitlements accrued by one or more of: purchase activity; promotional benefits; and
earned by usage.

161. Apparatus according to claim 146, wherein a transfer of a music content item by the music device management apparatus to a remote user music device implements part of a move or a copy of a content item between devices according to a collection map associated with the relevant user account.

162. Apparatus according to claim 146, wherein said management processor is further operable to cause deletion of a music content item on a remote user music device according to the collection map associated with the relevant user account.

163. A music content distribution apparatus configured to electronically distribute music content items for consumption on a plurality of remote user music devices, comprising:
a music content store holding a plurality of music content items for electronic distribution among a population of remote user devices;
music content distribution rules comprising electronic distribution rules defining consumption duration attributes by music content item, wherein consumption duration includes temporary consumption availability on an end user device;
a user music device interface through which user music content items can be transferred to said devices; and
a music content distribution processor operable to control distribution to a plurality of remote user devices according to duration attributes applying within said music content distribution rules.

164. A method of managing music content collections each of which is held across a plurality of remote user music devices associated with an account holder, the method comprising:
storing a plurality of collection maps on a server in communication with a network, each collection map indicating how music content items making up a music content item collection associated with a user account are held across a plurality of music devices associated with the user account; and
controlling a transfer of music content items from the server to individual remote user music devices according to the collection map associated with the relevant user account.

165. An article of manufacture comprising:
a machine readable storage medium; and
executable program instructions embodied in the machine readable storage medium that when executed by a programmable system cause the system to perform functions that manage music content collections each of which is held across a plurality of remote user music devices associated with an account holder, the functions comprising: storing a plurality of collection maps on a server in communication with a network, each collection map each indicating how music content items making up a music content item collection associated with a user account are held across a plurality of music devices associated with the user account; and controlling a transfer of music content items from the server to individual remote user music devices according to the collection map associated with the relevant user account.
